(19) United States
(12) Patent Application Publication
(10) Pub. No.: US 2015/0150109 A1
(43) Pub. Date: May 28, 2015

(54) AUTHENTICATED ACCESS TO A PROTECTED RESOURCE USING AN ENCODED AND SIGNED TOKEN

(71) Applicant: Adobe Systems Incorporated, San Jose, CA (US)

(72) Inventors: Tobias Bocanegra, San Francisco, CA (US); Antonio Sanso, Allschwil (CH); Timothee Maret, San Jose, CA (US)

(73) Assignee: Adobe Systems Incorporated, San Jose, CA (US)

(21) Appl. No.: 14/091,842

(22) Filed: Nov. 27, 2013

(51) Int. Cl. H04L 29/06

(52) U.S. Cl. CPC H04L 63/0853
USPC 726/9

(57) ABSTRACT

Techniques are disclosed for authenticated access to a protected resource. A third party application receives a request to access a protected resource, including a bearer token encoded in an HTTP Authorization request header field. The bearer token includes a client identification value that is encrypted and signed in a predefined syntax. The third party application determines whether the bearer token conforms to the predefined bearer token syntax, such as a JavaScript Object Notation Web Token syntax. If the bearer token conforms to the bearer token syntax, the client identification value is extracted from the bearer token. The client identification value is compared to a predefined list of authorized client identification values associated with the protected resource. If the client identification value matches any of the values on the list of authorized values, the bearer token is validated, which permits the third party application to access to the protected resource.

### FIELD OF THE DISCLOSURE

This disclosure relates generally to the field of data processing, and more particularly, to techniques for authenticated access to a protected resource using an encoded and signed token.

### BACKGROUND

A protected resource is one that is controlled within a secure environment. In a client-server computing environment, access to a protected resource residing on a server can be granted by an owner of the resource to a client if the client presents valid credentials, such as a username, password and/or other unique identification. However, sharing the same credentials with multiple entities can be undesirable since, among other things, the risk of compromising the security of the resource is increased if the credentials become available to another person and are used in a malicious manner. In some cases, the resource owner may authorize a third party to access the protected resource on behalf of the client without sharing the credentials with the third party. The third party may, for example, include an application executing on one server that is configured to access protected resources stored on a different server. Rather than providing the credentials to the third party, the resource owner or an authentication service that is trusted by the server holding the protected resources may instead provide an access token or other digital authority to the third party. The access token may then be used by the third party in lieu of the credentials to access the protected resource.

### BRIEF DESCRIPTION OF THE DRAWINGS

The accompanying drawings are not intended to be drawn to scale. In the drawings, each identical or nearly identical component that is illustrated in various figures is represented by a like numeral.

FIG. 1 illustrates an example user computing system configured in accordance with an embodiment of the present invention.

FIG. 2 illustrates an example use case for accessing a protected resource in accordance with an embodiment of the present invention.

FIG. 3 illustrates an example methodology for accessing a protected resource in accordance with an embodiment of the present invention.

### DETAILED DESCRIPTION

Techniques are disclosed for authenticated access to a protected resource. In general, client identification information is extracted from a bearer token, and that client identification information is used by a third-party application to perform authentication of the bearer token. In more detail, and in accordance with an embodiment, a third party application receives a request to access a protected resource. The request includes a bearer token encoded in an HTTP Authorization request header field. The bearer token includes a client identification value that is encrypted and signed in a predefined syntax. The third party application determines whether the bearer token conforms to the predefined syntax, such as a JavaScript Object Notation (JSON) Web Token (JWT) syntax or other suitable format for representing information to be transferred between two or more parties via a Uniform Resource Locator (URL) or other resource referent. The information may include, for example, one or more name/value pairs, where the names are strings and the values are arbitrary values. If the bearer token conforms to the predefined syntax, the client identification value is extracted from the bearer token. The client identification value is compared to a predefined list of authorized client identification values associated with the protected resource. Each authorized client identification value in the list is associated with a corresponding authentication configuration that specifies the correct authentication client to be used by the third-party application for validating the bearer token. If the client identification value matches any of the values on the list of authorized values, an authentication server is called by the corresponding authentication client to validate the bearer token. For instance, in one example embodiment, if the client identification value matches any of the values on the list of authorized values, an OAuth resource server is called by an OAuth client corresponding to an OSGi configuration for the matched client identification value to validate the bearer token, which, if validated, permits the third party application access to the protected resource. Numerous configurations and variations will be apparent in light of this disclosure.

General Overview

As mentioned above, access to a protected resource residing on a server can be granted to a third party by an owner of the resource using an access token in lieu of valid credentials, such as a username, password and/or other unique identification. One solution, called single sign-on, includes utilizing an authentication server that has a trusted relationship with the resource owner. When the third party needs to access the secure data, it can request authorization from the authentication server. In this manner, the authentication server uses the credentials that are recognized by the resource owner on behalf of the third party, and returns a token to the third party that can be used to gain access to the data. However, this solution requires establishing of the authentication server and maintaining the trust relationships between the authentication server and various resource owners.

Thus, and in accordance with an embodiment of the present invention, techniques are provided herein for authenticated access to a protected resource using a special authorization token. In one specific embodiment, a third party application receives a request from a client to access a protected resource. The request to access the protected resource can be a component of an HTTP request message header that includes a bearer token. The bearer token may, for example, be encoded in an HTTP Authorization request header field or other portion of the message. The bearer token includes a client identification value that can have a predefined syntax. The bearer token and/or data encoded in the token may be encrypted and/or signed for additional security. The third party application determines whether the bearer token conforms to the predefined bearer token syntax, such as a JSON Web Token (JWT) format. If the bearer token conforms to the bearer token syntax, the client identification value is extracted from the bearer token. The client identification value is compared to a predefined list of authorized client identification values associated with the protected resource. Each authorized client identification value in the list is associated with a corresponding configuration (e.g., an OSGi configuration) that specifies the correct authentication client (e.g., an OAuth client) to be used for validating the bearer token. In one such example case, if the client identification value matches any of the values on the list of authorized values, an authentication server (e.g., an OAuth resource server) is called by an OAuth client corresponding to an OSGi configuration for the matched client identification value to validate the bearer token, which, if validated, permits the third party application to access to the protected resource. Otherwise, the client (and, accordingly, the third party application) is considered to be unauthorized to access the protected resource, and the bearer token is not validated.

As used herein, the term “resource,” in addition to its plain and ordinary meaning, includes, but is not limited to, anything or any entity that can be identified, named, addressed or handled in any networked information system, such as the World Wide Web. A protected resource is one that is controlled within a secure environment and to which access is restricted to entities (e.g., clients, servers, applications, scripts, components, etc.) authorized by the owner of the resource. Some specific examples of protected resources include data, electronic documents, files, web pages, images, objects, services, and collections of resources and/or generally anything that has an identity and can be referenced in some manner. Some protected resources that are secured under an OAuth framework, such as described below, can be accessed by the third party application using Hypertext Transfer Protocol (HTTP) messages, specifically including the HTTP/1.1 standard protocol (currently defined by the Internet Engineering Task Force (IETF) Request for Comments (RFC) 2616), although it will be apparent in light of this disclosure that other application and authentication protocols can be used to access protected resources using the techniques disclosed herein.

OAuth is a standard protocol that enables a third party client to access protected resources by obtaining an access token, rather than using the resource owner's credentials directly. Such an access token is defined, for example, in “The OAuth 2.0 Authorization Framework” of RFC 6749 as “a string representing an access authorization issued to the client.” In general, before a client can access a protected resource, it must first obtain an authorization grant from the resource owner and then exchange the authorization grant for an access token. The access token provides an abstraction, replacing different authorization constructs (e.g., username and password, assertion) for a single token understood by the resource server. This abstraction allows access tokens to be issued, for example, to a third party without compromising the integrity of other authorization credentials. The access token also eliminates the need for the resource server to accommodate multiple different authentication schemes. The access token can represent, in one specific example, the scope, duration, and/or other attributes of the authorization grant. Once acquired, the third party can present a valid access token to the resource server, which permits access to the appropriate protected resources stored on the server. In some cases, the third party client can present its own credentials to an authorization server to obtain an access token without having to first obtain an authorization grant directly from the resource owner. Such tokens are issued to clients by the authorization server with the approval of the resource owner.

As used herein, the term “bearer token,” in addition to its plain and ordinary meaning, includes a security token with the property that any party in possession of the token (a “bearer”) can use the token in any way that any other party in possession of it can. Using a bearer token does not require a bearer to prove possession of cryptographic key material (proof-of-possession). A bearer token can include any value, string of characters or combinations thereof. For instance, the format and content of the bearer token may conform to an established protocol, such as OAuth 2.0.

In one embodiment, an OAuth access token can be encoded in a bearer token that complies with HTTP/1.1 (e.g., as defined in RFC2616) using Transport Layer Security (TLS) (e.g., as defined in RFC5246). When sending the bearer token in the “Authorization” request header field defined by HTTP/1.1 (e.g., as defined in RFC2617), the client uses the “Bearer” authentication scheme to transmit the access token. The syntax of the Authorization request header field for this authentication scheme may, for example, follow the usage of the Basic scheme defined in Section 2 of RFC2617. For example:

GET /protected_resource HTTP/1.1
Host: server.example.com
Authorization: Bearer mF_9.B5f-4.1JqM

JSON Web Token (JWT) is a compact information representation format intended for space constrained environments such as HTTP Authorization headers and URI query parameters. JWTs encode information to be transmitted as a JavaScript Object Notation (JSON) object (e.g., as defined by RFC4627) that is used as the payload of a JSON Web Signature (JWS) structure or as the plaintext of a JSON Web Encryption (JWE) structure, enabling the information to be digitally signed and/or encrypted. A JWT can be represented as a sequence of URL-safe parts separated by period (‘.’) characters. Each part can contain a base64url encoded value. In one specific embodiment, a JWT can be encoded and signed in three parts. The first part includes a JWT header, the second part includes a JWT payload, including a client identification value associated with the client that is requesting access to a protected resource, and the third part includes an encoded JWT signature. For example:

Authorization: Bearer
<encoded JWT header>.<encoded JWT payload>.<encoded JWT
signature>

The JWT header defines the object type (e.g., that the object is a JWT) and the encoding algorithm used to encode the object. Encoding the octets of the UTF-8 representation of the JWT header using base64url yields the encoded JWS header. The JWT payload defines the information in the JWT. The client identification value can form at least a portion of the information. Encoding the octets of the UTF-8 representation of the JWT payload using base64url yields the encoded JWS payload. Signing the encoded JWS header and encoded JWS payload with a signing algorithm, such as a keyed-hash message authentication code (HMAC) SHA-256 algorithm, and encoding the signature using base64url yields the encoded JWS signature. As described above, the encoded JWS header, payload and signature are concatenated in order with period (‘.’) characters between each part to produce the bearer token. For example:

Authorization: Bearer
eyJhbGciOiJSUzI1NiJ9.eyJpZCI6ImJhYjMxMzI4LTI5MzktNDcxNC05OGMzLWQwNmZhYj
QxZDE4YyIsImNyZWF0ZWRfYXQiOiIxMzEwNTc3MzkzODI0IiwiZXhwaXJlc19pbiI6Ijg2N
DAwMDAwIiwidXNlcl9pZCI6Im1vbml0b3JAQWRvYmVJRCJ9.B94lGlEgeDsTkSqqvKaGEHL
TzoEs7tgkSqk3frLZGgaD9bE8UkBV2ZkoZSpKhQGJGHvE_o09iM2U31W_USIfuce0m2DMOP
XSz4ewsXSPt2Wscti_O4kJDqtMWPt9pkBYk4Y4Tdz4yBoj5iOxJEYwzTC9nMOAfzdZtJrdt
G8ShCoInTeJlDigD5QUvtmC9rw5MEku8tvWVncCxb_T_PHr0EKI5V4u_O_V3CXNBfHzhGBh
jy4Pa2z8SztthOPy1LXQHNZ2A6GPsXYkb0jDms_K1jcb4fElsi5Z9xjWQRX15fF2s1wLJIL
SamaILwv15mTLS9-X_wNU--Qy0k1QmOpx9A

OSGi is a middleware framework in which applications, also referred to as bundles, can be dynamically installed and deleted using Java. Each bundle forms a fundamental unit of service deployment and management. Accordingly, OSGi-compliant devices can download and install OSGi bundles, and remove them when they are no longer required. In some embodiments, an OAuth access token, such as a bearer token as variously described herein, can be used to permit any application running in an OSGi-compliant environment, including a third party application, to access a protected resource.

As used herein, the term “client,” in addition to its plain and ordinary meaning, includes any computing device and/or software application that accesses a remote service or application provided by another computing device. A client may include, for example, a user computing system or application that accesses services and/or data provided by a remote system via a communications network, such as the Internet and/or a company intranet or other wired/wireless network. As used herein, the term “server,” in addition to its plain and ordinary meaning, includes any computing device that provides one or more services, such as applications and data, to one or more clients.

System Architecture

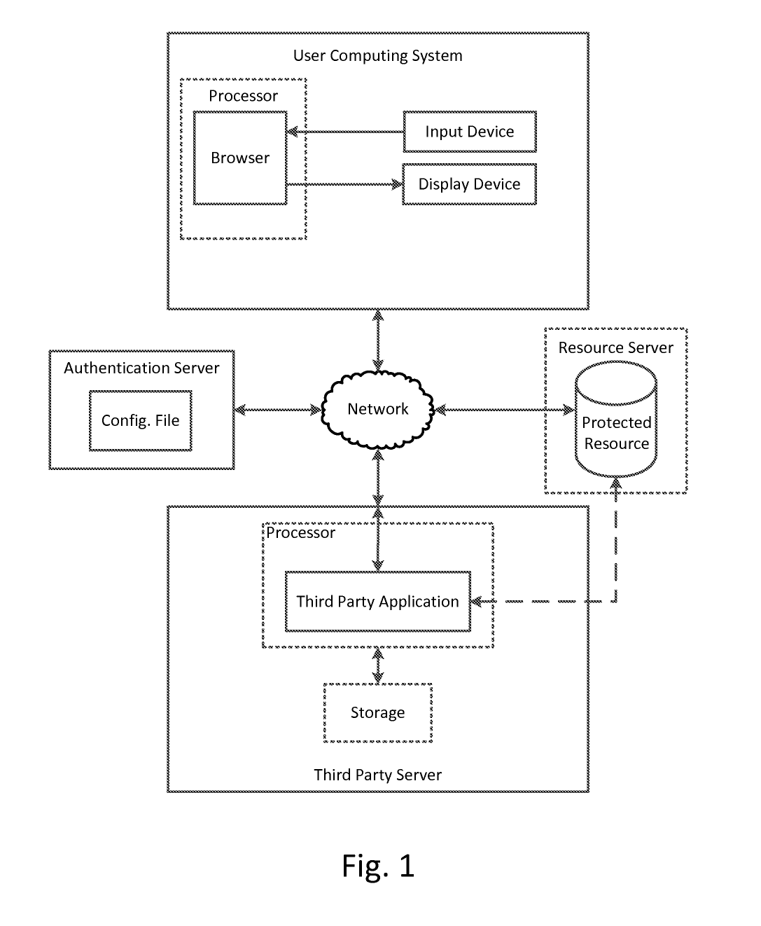

FIG. 1 illustrates an example system for authenticated access to a protected resource. The system includes a user computing system, an authentication server, a third party server, and a resource server communicatively coupled to each other via a network. The user computing system includes a processor configured to execute a browser or other suitable user application for accessing and interacting with a third party application executable by a processor on the third party server, and for accessing the protected resource. The browser interacts with one or more input devices, such as a keyboard and mouse, and one or more display devices. The third party application may include, for example, a collaboration tool for developing a marketing campaign or other type of website, such as a version of Adobe Experience Manager or other suitable application. In some cases, the third party application forms part of software as a service (SaaS). As used herein, the term “software as a service,” in addition to its plain and ordinary meaning, includes a service delivery model in which a client-accessible application and associated data are centrally hosted on a network-based server. In some other cases, the third party application can reside locally on the user computing system or on another network-connected device. The authentication server can include software configured to enable the third party application to access the protected resource by obtaining an access token, rather than using the resource owner's credentials directly, using the OAuth 2.0 protocol or other suitable protocol. The protected resource may be housed on the resource server or on another server accessible by the third party server via the network. The system may include additional components and still fall within the scope of the disclosed embodiments. The browser can be any of a number of browsers, including, for example, Microsoft Internet Explorer®, Mozilla Firefox®, Safari®, Google Chrome®, and Opera®. The user computing system can be configured to execute any of a number of operating systems, such as Microsoft Windows®, Mac OS®, iOS®, Google Android® and any one of the Linux®-based operating systems. The user computing system can be implemented with any suitable computing device, such as a laptop, desktop, tablet computer, smartphone, or other suitable computing device capable of receiving input from a user and providing a GUI via the display. The protected resource can be stored, for example, using any suitable type of memory, such as a disk drive included in, or otherwise in communication with, the browser and/or the third party application. Other suitable memories include flash memory, random access memory (RAM), a memory stick or thumb drive, USB drive, cloud storage service, etc. In a more general sense, any memory facility can be used to store and maintain the protected resource. Further, there can be any number of separate facilities for storing one or more protected resources, each accessible by the user computing system and/or server via the network. The network can be any communications network, such as a local area network or the Internet, or any other public and/or private communication network. Such a system may be suitable, for example, for providing authenticated access to a protected resource using techniques as variously described herein.

It will be appreciated that, in some embodiments, various functions performed by the user computing system, the third party server, the authentication server and the resource server, as described herein, can performed by similar processors and/or storage devices in different configurations and arrangements, and that the depicted embodiments are not intended to be limiting. Various components of this example embodiment can be integrated into, for example, one or more desktop or laptop computers, workstations, tablets, smartphones, game consoles, set-top boxes, or other such computing devices. Other componentry and modules typical of a computing system, such as processors (e.g., central processing unit and co-processor, graphics processor, etc.), input devices (e.g., keyboard, mouse, touch pad, touch screen, etc.), and operating system, are not shown but will be readily apparent. Various components of the system shown in FIG. 1, such as the browser and third party application, can be implemented in software, such as a set of instructions (e.g., C, C++, object-oriented C, JavaScript, Java, BASIC, etc.) encoded on any computer readable medium or computer program product (e.g., hard drive, server, disc, or other suitable non-transient memory or set of memories), that when executed by one or more processors, cause the various methodologies provided herein to be carried out. In other embodiments, the functional components/modules may be implemented with hardware, such as gate level logic (e.g., FPGA) or a purpose-built semiconductor (e.g., ASIC). Still other embodiments may be implemented with a microcontroller having a number of input/output ports for receiving and outputting data, and a number of embedded routines for carrying out the functionality described herein. In a more general sense, any suitable combination of hardware, software, and firmware can be used, as will be apparent.

Example Use Case

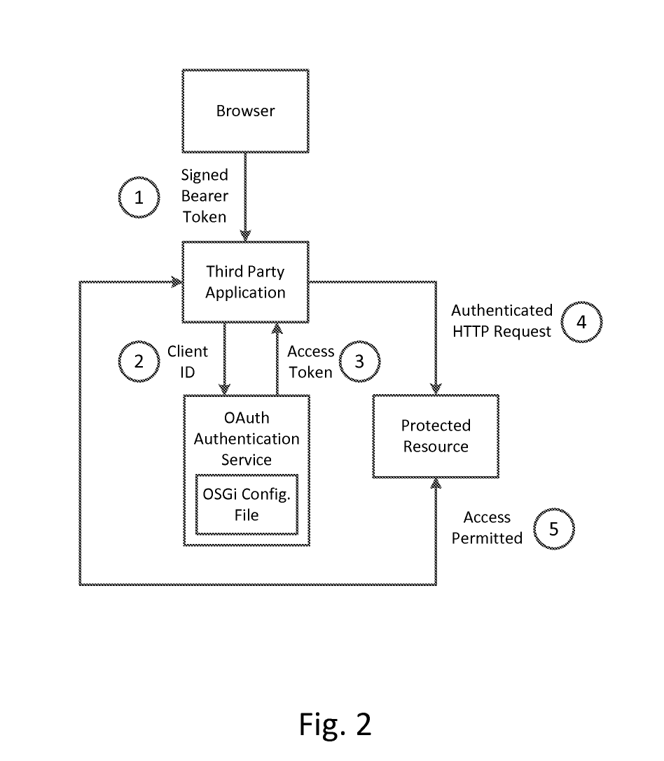

FIG. 2 illustrates an example use case for accessing a protected resource in accordance with an embodiment. At reference 1, a third party application receives, from a browser or other suitable user application, an HTTP request to access the protected resource, which is held by a protected resource server. The HTTP request includes a bearer token in the request header. In some embodiments, the bearer token and/or at least a portion of the contents of the bearer token can be encrypted. The third party application determines whether the bearer token conforms to a predefined bearer token syntax. In some embodiments, the bearer token is a JWT Bearer Token having a Base64 encoded string split into three parts by a dot (‘.’). The token can be signed with a digital signature for verification of its origin. If the third party application determines that the bearer token conforms to the predefined bearer token syntax, a client identification value is extracted from the bearer token. In some embodiments, the client identification value can be included in a JWT claim set encoded in the bearer token. At reference 2, the extracted client identification value is compared to a configuration file by an authentication service. In some embodiments, the configuration file includes an OSGi configuration. The configuration file can be used to authenticate the bearer token against a list of client identification values stored in the configuration file. At reference 3, if the client identification value matches one in the list, the bearer token is verified by the OAuth Authentication Service, which returns an access token to the third party application. At reference 4, the access token can be used to send an authenticated HTTP request to the resource server holding the protected resource. At reference 5, the third party application is permitted access to the protected resource.

Example Methodology for Accessing a Protected Resource

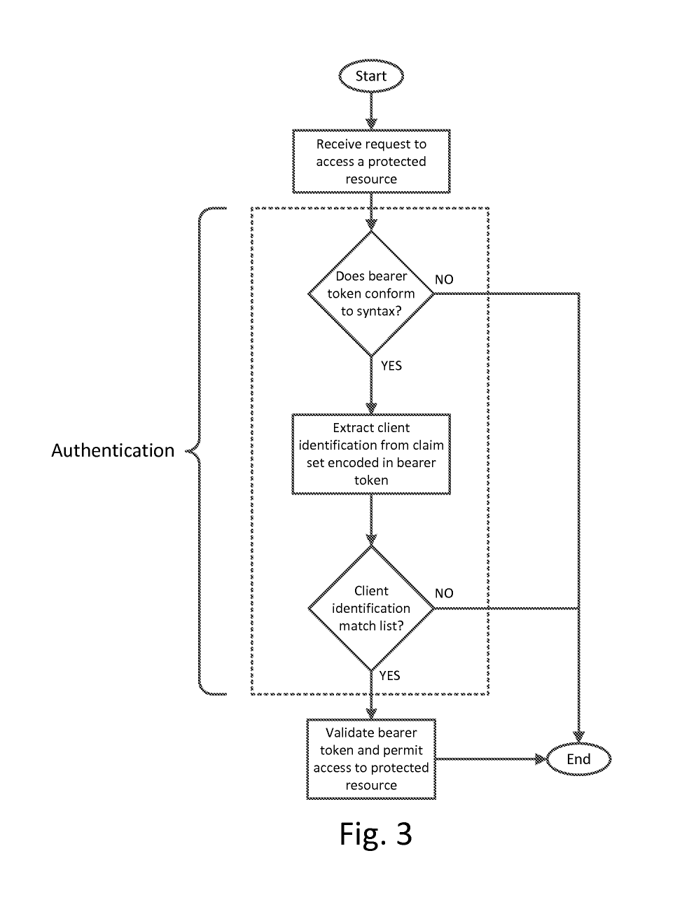

FIG. 3 illustrates an example methodology for accessing a protected resource in accordance with an embodiment. The method begins by receiving a request from a client to access the protected resource. For example, the request may be generated by the browser of FIG. 1. The request can be an HTTP request having a bearer token encoded in the request header. In accordance with embodiments of the present invention, the client is authenticated for access to the protected resource based on a client identification value encoded in the bearer token. When and if the client is authenticated, access to the protected resource is then permitted. In one specific embodiment, authentication includes determining whether the bearer token conforms to a predefined syntax, extracting a client identification value from the claim set encoded in the bearer token, and determining whether the client identification value matches a list of valid client identification values. For instance, if the bearer token conforms to a predefined syntax, such as a JWT Bearer Token formed by a three-part Base64 encoded string as described above, a client identification value is extracted from the bearer token; otherwise, the method ends. If the client identification value matches an authorized client identification value in a list, such as in an OAuth OSGi configuration file, an authentication server (e.g., an OAuth resource server) is called by an OAuth client corresponding to an OSGi configuration for the matched client identification value to validate the bearer token, which, if valid, permits the client to access the protected resource. Otherwise, if the client identification value is not a valid client identification value, the method ends and consequently the third party application is not granted access to the protected resource. Access to the protected resource may be achieved, for example, using an access token generated in response to validation of the bearer token.

Numerous embodiments will be apparent in light of the present disclosure, and features described herein can be combined in any number of configurations. One example embodiment provides a computer-implemented method. The method includes receiving an input from a client requesting access to a protected resource by a third party application, the input including a bearer token in an HTTP Authorization request header field; comparing a client identification value encoded in the bearer token to a predefined list of authorized client values associated with the protected resource, and validating the bearer token based on the comparison, where the client identification value matches an authorized client value in the predefined list. In some cases, the method includes determining whether the bearer token conforms to a predefined bearer token syntax. In some such cases, the predefined bearer token syntax includes an encoded three-part Base64 JavaScript Object Notation Web Token string. In some cases, the method includes permitting the third party application to access the protected resource in response to the validation of the bearer token. In some cases, the predefined list of authorized client values is included in an OAuth Open Service Gateway initiative environment configuration. In some cases, the client identification value is encrypted in the bearer token. In some cases, the bearer token is digitally signed. In some cases, some or all of the functions variously described in this paragraph can be performed in any order and at any time by one or more different user computing systems.

Another example embodiment provides a system having a storage and a processor operatively coupled to the storage. The processor is configured to execute instructions stored in the storage that when executed cause the processor to carry out a process including receiving an input from a client requesting access to a protected resource by a third party application, the input including a bearer token in an HTTP Authorization request header field; comparing a client identification value encoded in the bearer token to a predefined list of authorized client values associated with the protected resource, and validating the bearer token based on the comparison, where the client identification value matches an authorized client value in the predefined list. In some cases, the authenticating further includes determining whether the bearer token conforms to a predefined bearer token syntax. In some such cases, the predefined bearer token syntax includes an encoded three-part Base64 JavaScript Object Notation Web Token string. In some cases, the method includes permitting the third party application to access the protected resource in response to the validation of the bearer token. In some cases, the predefined list of authorized client values is included in an OAuth Open Service Gateway initiative environment configuration. In some cases, the client identification value is encrypted in the bearer token. In some cases, the bearer token is digitally signed. Another example embodiment provides a non-transient computer-readable medium or computer program product having instructions encoded thereon that when executed by one or more processors cause the processor(s) to perform one or more of the functions variously described in this paragraph.

The foregoing description and drawings of various embodiments are presented by way of example only. These examples are not intended to be exhaustive or to limit the invention to the precise forms disclosed. Alterations, modifications, and variations will be apparent in light of this disclosure and are intended to be within the scope of the invention as set forth in the claims.

What is claimed is:

1. A computer-implemented method comprising:
receiving an input from a client requesting access to a protected resource by a third party application, the input including a bearer token in an HTTP Authorization request header field;
comparing a client identification value encoded in the bearer token to a predefined list of authorized client values associated with the protected resource; and
validating the bearer token based on the comparison, wherein the client identification value matches an authorized client value in the predefined list.

2. The method of claim 1, further comprising determining whether the bearer token conforms to a predefined bearer token syntax.

3. The method of claim 2, wherein the predefined bearer token syntax includes an encoded three-part Base64 JavaScript Object Notation Web Token string.

4. The method of claim 1, further comprising permitting the third party application to access the protected resource in response to the validation of the bearer token.

5. The method of claim 1, wherein the predefined list of authorized client values is included in an OAuth Open Service Gateway initiative environment configuration.

6. The method of claim 1, wherein the client identification value is encrypted in the bearer token.

7. The method of claim 1, wherein the bearer token is digitally signed.

8. A system comprising:
a storage; and
a processor operatively coupled to the storage and configured to execute instructions stored in the storage that when executed cause the processor to carry out a process comprising:
receiving an input from a client requesting access by a third party application to a protected resource, the input including a bearer token in an HTTP Authorization request header field;
comparing a client identification value encoded in the bearer token to a predefined list of authorized client values associated with the protected resource; and
validating the bearer token based on the comparison, wherein the client identification value matches an authorized client value in the predefined list.

9. The system of claim 8, further comprising determining whether the bearer token conforms to a predefined bearer token syntax.

10. The system of claim 9, wherein the predefined bearer token syntax includes an encoded three-part Base64 JavaScript Object Notation Web Token string.

11. The system of claim 8, further comprising permitting the third party application to access the protected resource in response to the validation of the bearer token.

12. The system of claim 8, wherein the predefined list of authorized client values is included in an OAuth Open Service Gateway initiative environment configuration.

13. The system of claim 8, wherein the client identification value is encrypted in the bearer token.

14. The system of claim 8, wherein the bearer token is digitally signed.

15. A non-transient computer program product having instructions encoded thereon that when executed by one or more processors cause a process to be carried out, the process comprising:
receiving an input from a client requesting access to a protected resource by a third party application, the input including a bearer token in an HTTP Authorization request header field;
comparing a client identification value encoded in the bearer token to a predefined list of authorized client values associated with the protected resource; and
validating the bearer token based on the comparison, wherein the client identification value matches an authorized client value in the predefined list.

16. The computer program product of claim 15, further comprising determining whether the bearer token conforms to a predefined bearer token syntax.

17. The computer program product of claim 16, wherein the predefined bearer token syntax includes an encoded three-part Base64 JavaScript Object Notation Web Token string.

18. The computer program product of claim 15, further comprising permitting the third party application to access the protected resource in response to the validation of the bearer token.

19. The computer program product of claim 15, wherein the predefined list of authorized client values is included in an OAuth Open Service Gateway initiative environment configuration.

20. The computer program product of claim 15, wherein the bearer token is digitally signed.
